(19) United States
(12) Patent Application Publication
(10) Pub. No.: US 2022/0313045 A1
(43) Pub. Date: Oct. 6, 2022

(54) ROBOT, CONTROL METHOD FOR ROBOT, AND STORAGE MEDIUM

(71) Applicant: MIDEA ROBOZONE TECHNOLOGY CO., LTD., SUZHOU (CN)

(72) Inventors: Lei GAO, SUZHOU (CN); Yuan CHEN, SUZHOU (CN); Xiaoming XU, SUZHOU (CN); Tong CHEN, SUZHOU (CN)

(21) Appl. No.: 17/614,309

(22) PCT Filed: Apr. 2, 2020
(86) PCT No.: PCT/CN2020/083039

§ 371 Date: Nov. 24, 2021

(30) Foreign Application Priority Data
May 27, 2019 (CN) 201910448046.2

(51) Int. Cl. A47L 11/40; A47L 11/32; A47L 11/24; G05D 1/02

(52) U.S. Cl. CPC A47L 11/4011; A47L 11/32; A47L 11/24; G05D 1/0223; A47L 11/4066; A47L 2201/04; A47L 2201/06

(57) ABSTRACT

The present disclosure provides a robot, a control method for robot and a storage medium, the robot includes a memory, a processor and a computer program stored on the memory and running on the processor, and when the processor executes the computer program to obtain, material information of a working surface and determine, a target running speed of the robot according to the material information, and control the robot to run at the target running speed. The robot provided by the present disclosure controls the operating speed according to the material information of the working surface, and the robot can clean at different speeds for different materials when cleaning. If the detected material of the working surface is a material that is not easy to clean, you can set the speed to a low speed mode accordingly.

### CROSS-REFERENCES TO RELATED APPLICATIONS

The present disclosure is a national phase application of International Application No. PCT/CN2020/083039, filed on Apr. 2, 2020, which claims priority to Chinese Patent Application No. 201910448046.2 filed with China National Intellectual Property Administration on May 27, 2019, the entireties of which are herein incorporated by reference.

### FIELD

The present disclosure relates to the field of household appliances, specifically, relates to a robot, a control method for robot and a storage medium.

### BACKGROUND

At present, with the gradual improvement of people's life quality, there are more and more types of sweeping robots, and more and more functions. However, as a smart robot for home services, the cleaning effect is the most basic and most concerned function. Due to the different home environment, the ground material is also different, but the sweeping robots move on the ground at the same speed, which will cause uneven ground cleaning effects.

### SUMMARY

The present disclosure aims to solve at least one of the problems existing in the existing technology or related technologies.

Some embodiments of the present disclosure provide a robot.

One embodiment of the present disclosure provides a control method for robot.

Another embodiment of the present disclosure provides a computer-readable storage medium.

The embodiments of the present disclosure provide a robot, including a memory, a processor and a computer program stored on the memory and running on the processor, and when the processor executes the computer program, the following steps are implemented obtaining, material information of a working surface; and determining, a target running speed of the robot according to the material information, and control the robot to run at the target running speed.

The robot provided by the present disclosure can detect the material information of the working surface, and different materials will have different cleaning difficulties. For example, carpets are more difficult to clean than floors. If they move at the same speed when passing through the carpet and passing the floor, the carpet will not be cleaned properly. However, in the embodiment provided by the present disclosure, the robot controls the operating speed according to the material information of the working surface, that is, changes the moving speed of the robot according to the different materials, so that the robot can clean at different speeds for different materials when cleaning. If the detected material of the working surface is a material that is not easy to clean, you can set the speed to a low speed mode accordingly, and then when passing through the working surface that is not easy to clean, at the same cleaning frequency, that is, under the condition that the working frequency of the rolling brush remains unchanged, by slowing down the moving speed of the robot, you can clean the working surface that is not easy to clean at one time, to improve the cleaning effect of the robot. At the same time, compared with the related technology, in order to clean the carpet that is not easy to clean and let the robot clean the carpet multiple times, by slowly moving at a time to clean the carpet, it can reduce the possibility of collision between the robot and other movable objects, to improve the robot cleaning coverage, save user time and improve cleaning efficiency.

According to the above-mentioned robot provided by the present disclosure, it may also have the following additional embodiments.

In the above-mentioned embodiments, furthermore, the step of determining the target running speed of the robot according to the material information is implemented when the processor executes the computer program, which is specifically implemented: comparing, the material information with stored material information; and determining, a running speed corresponding to the stored material information matching with the material information is the target running speed.

In this embodiment, the material information of a variety of working surfaces is stored in the robot in advance to form the stored material information, and the running speed corresponding to the stored material information is stored in the robot, that is, the optimal moving speed corresponding to different materials is stored in the robot in advance. After robot detects the material information of the working surface, it compares the detected material information with the stored material information, and uses the running speed corresponding to the stored material information that matches with the material information as the target running speed, and then moving at different speeds according to different materials.

Furthermore, each material corresponds to a running speed.

In any one of the above-mentioned embodiments, furthermore, the step of determining the target running speed of the robot according to the material information is implemented when the processor executes the computer program, which is specifically implemented: confirming, a corresponding material type according to the material information, and the material type includes an easy-to-clean type and a difficult-to-clean type; determining, the material information is of the easy-to-clean type, and control the robot to run at a first speed; and determining, the material information is of the difficult-to-clean type, and control the robot to run at a second speed, and the first speed is greater than the second speed.

In this embodiment, by storing the variety of materials in the robot in advance, and dividing the variety of material information into different material types according to the difficulty of cleaning, the material types include easy-to-clean type and difficult-to-clean type, the easy-to-clean type and the difficult-to-clean type correspond to a running speed. When it is determined that the material information is easy-to-clean type, control the robot to run at the first speed, and when it is determined that the material information is difficult-to-clean type, control the robot to run at the second speed. In one embodiment, the first speed is greater than the second speed, so that when the material information is the easy-to-clean type, the robot moves at a faster speed, and when the material information is the difficult-to-clean type, the robot moves at a slower speed to improve the cleaning efficiency of the robot.

Specifically, the first speed and the second speed are the running speeds preset in the robot. The easy-to-clean type includes marble and wooden floors, etc., and the difficult-to-clean type includes fiber materials, cotton and linen materials, etc.

In any one of the above-mentioned embodiments, furthermore, before the step of obtaining the material information of the working surface is implemented when the processor executes the computer program, it further implements: starting, the cleaning program; and controlling, the robot to run at a third speed, and the third speed is greater than or equal to the target running speed.

In this embodiment, by turning on the cleaning program of the robot, the robot starts cleaning, turns on the detection function of the material of the working surface, and runs at the initial speed, which is the third speed, and then changes the moving speed according to the different materials detected. In one embodiment, the third speed is the moving speed preset in the robot, and the third speed is greater than or equal to the target running speed.

In any one of the above-mentioned embodiments, furthermore, when the processor executes the computer program, it further implements: receiving, a stopping cleaning instruction;

and stopping, obtaining the material information of the working surface, and close the cleaning program.

In this embodiment, when the robot cleaning is completed or when a stop instruction is received, stop obtaining the material information of the working surface, and close the cleaning program.

Specifically, the robot is a sweeping robot. When the sweeping robot receives a start instruction and starts cleaning, it turns on the material detection function of the working surface and starts running at a constant speed. When it is detected that the ground is a material that is not easy to clean (carpet, etc.), the sweeping robot will automatically be set to low speed mode. When it detected that the ground is of other materials, the sweeping robot will automatically be set to normal mode; when the sweeping robot finishes cleaning or receives a stop command, the ground material detection function is turned off and the cleaning is stopped.

According to some embodiments of the present disclosure, a control method for robot is also provided, comprising: obtaining, material information of a working surface; and determining, a target running speed of the robot according to the material information, and control the robot to run at the target running speed.

The robot provided by the present disclosure can detect the material information of the working surface, and different materials will have different cleaning difficulties. For example, carpets are more difficult to clean than floors. If they move at the same speed when passing through the carpet and passing the floor, the carpet will not be cleaned properly. However, in the embodiment provided by the present disclosure, the robot controls the operating speed according to the material information of the working surface, that is, changes the moving speed of the robot according to the different materials, so that the robot can clean at different speeds for different materials when cleaning. If the detected material of the working surface is a material that is not easy to clean, you can set the speed to a low speed mode accordingly, and then when passing through the working surface that is not easy to clean, at the same cleaning frequency, that is, under the condition that the working frequency of the rolling brush remains unchanged, by slowing down the moving speed of the robot, you can clean the working surface that is not easy to clean at one time, to improve the cleaning effect of the robot. At the same time, compared with the related technology, in order to clean the carpet that is not easy to clean and let the robot clean the carpet multiple times, by slowly moving at a time to clean the carpet, it can reduce the possibility of collision between the robot and other movable objects, to improve the robot cleaning coverage, save user time and improve cleaning efficiency.

According to the above-mentioned robot provided by the present disclosure, it may also have the following additional features.

In the above-mentioned embodiments, furthermore, the step of determining the target running speed of the robot according to the material information specifically includes: comparing, the material information with stored material information; and determining, a running speed corresponding to the stored material information matching with the material information is the target running speed.

In this embodiment, the material information of a variety of working surfaces is stored in the robot in advance to form the stored material information, and the running speed corresponding to the stored material information is stored in the robot, that is, the optimal moving speed corresponding to different materials is stored in the robot in advance. After robot detects the material information of the working surface, it compares the detected material information with the stored material information, and uses the running speed corresponding to the stored material information that matches with the material information as the target running speed, and then achieve the effect of moving at different speeds according to different materials.

Furthermore, each material corresponds to a running speed.

In any one of the above-mentioned embodiments, furthermore, the step of determining the target running speed of the robot according to the material information specifically includes: confirming, a corresponding material type according to the material information, and the material type includes an easy-to-clean type and a difficult-to-clean type; determining, the material information is of the easy-to-clean type, and control the robot to run at a first speed; and determining, the material information is of the difficult-to-clean type, and control the robot to run at a second speed, and the first speed is greater than the second speed.

In this embodiment, by storing the variety of materials in the robot in advance, and dividing the variety of material information into different material types according to the difficulty of cleaning, the material types include easy-to-clean type and difficult-to-clean type, the easy-to-clean type and the difficult-to-clean type correspond to a running speed. When it is determined that the material information is easy-to-clean type, control the robot to run at the first speed, and when it is determined that the material information is difficult-to-clean type, control the robot to run at the second speed. In one embodiment, the first speed is greater than the second speed, so that when the material information is the easy-to-clean type, the robot moves at a faster speed, and when the material information is the difficult-to-clean type, the robot moves at a slower speed to improve the cleaning efficiency of the robot.

Specifically, the first speed and the second speed are the running speeds preset in the robot. The easy-to-clean type includes marble and wooden floors, etc., and the difficult-to-clean type includes fiber materials, cotton and linen materials, etc.

In any one of the above-mentioned embodiments, furthermore, before the step of obtaining the material information of the working surface, it further includes: starting, the cleaning program; and controlling, the robot to run at a third speed, and the third speed is greater than or equal to the target running speed.

In this embodiment, by turning on the cleaning program of the robot, the robot starts cleaning, turns on the detection function of the material of the working surface, and runs at the initial speed, which is the third speed, and then changes the moving speed according to the different materials detected. In one embodiment, the third speed is the moving speed preset in the robot, and the third speed is greater than or equal to the target running speed.

In any one of the above-mentioned embodiments, furthermore, further comprising: receiving, a stopping cleaning instruction; and stopping, obtaining the material information of the working surface, and close the cleaning program.

In this embodiment, when the robot cleaning is completed or when a stop instruction is received, stop obtaining the material information of the working surface, and close the cleaning program.

Specifically, the robot is a sweeping robot. When the sweeping robot receives a start instruction and starts cleaning, it turns on the material detection function of the working surface and starts running at a constant speed. When it is detected that the ground is a material that is not easy to clean (carpet, etc.), the sweeping robot will automatically be set to low speed mode. When it detected that the ground is of other materials, the sweeping robot will automatically be set to normal mode; when the sweeping robot finishes cleaning or receives a stop command, the ground material detection function is turned off and the cleaning is stopped.

According to other embodiments of the present disclosure, a computer-readable storage medium is also provided, on which a computer program is stored, and when the computer program is executed by a processor, the steps of the method described in any one of the above-mentioned embodiments is implemented.

Additional embodiments of the present disclosure will become apparent in the following description or will be learned by practice of the present disclosure.

### BRIEF DESCRIPTION OF THE DRAWINGS

The above and/or additional embodiments of the present disclosure will become apparent and readily understood from the description of embodiments in conjunction with the following drawings:

FIG. 1 shows a schematic block diagram of a robot of an embodiment of the present disclosure;

FIG. 2 shows a schematic flow diagram of a control method for robot of an embodiment of the present disclosure;

FIG. 3 shows another schematic flow diagram of a control method for robot of an embodiment of the present disclosure;

FIG. 4 shows a schematic flow diagram of a control method for robot of an embodiment of the present disclosure;

FIG. 5 shows a schematic flow diagram of a control method for robot of an embodiment of the present disclosure.

### DETAILED DESCRIPTION OF THE DISCLOSURE

In order for the embodiments of the present disclosure to be understood more clearly, a further detailed description of the present disclosure will be given below in connection with the accompanying drawings and embodiments. It should be noted that the embodiments of the present disclosure and the features in the embodiments can be combined with each other if there is no conflict.

In the following description, numerous details are set forth in order to provide a thorough understanding of the present disclosure. However, the present disclosure can also be implemented in other manners than those described herein. Therefore, the protection scope of the present disclosure is not limited to the embodiments disclosed below.

The following describes a robot 1, a control method for robot and a storage medium according to some embodiments of the present disclosure with reference to FIGS. 1 to 5.

According to an embodiment of the first aspect of the present disclosure, the present disclosure provides a robot 1, including a memory 12, a processor 14 and a computer program stored on the memory 12 and running on the processor 14, and when the processor 14 executes the computer program, the following steps are implemented: obtaining, material information of a working surface; and determining, a target running speed of the robot 1 according to the material information, and control the robot 1 to run at the target running speed.

As shown in FIG. 1, the robot 1 provided by the present disclosure can detect the material information of the working surface, and different materials will have different cleaning difficulties. For example, carpets are more difficult to clean than floors. If they move at the same speed when passing through the carpet and passing the floor, the carpet will not be cleaned properly. However, in the embodiment provided by the present disclosure, the robot 1 controls the operating speed according to the material information of the working surface, that is, changes the moving speed of the robot 1 according to the different materials, so that the robot 1 can clean at different speeds for different materials when cleaning. If the detected material of the working surface is a material that is not easy to clean, you can set the speed to a low speed mode accordingly, and then when passing through the working surface that is not easy to clean, at the same cleaning frequency, that is, under the condition that the working frequency of the rolling brush remains unchanged, by slowing down the moving speed of the robot, you can clean the working surface that is not easy to clean at one time, to improve the cleaning effect of the robot. At the same time, compared with the related technology, in order to clean the carpet that is not easy to clean and let the robot 1 clean the carpet multiple times, by slowly moving at a time to clean the carpet, it can reduce the possibility of collision between the robot 1 and other movable objects, to improve the robot 1 cleaning coverage, save user time and improve cleaning efficiency.

In the above-mentioned embodiment, furthermore, the step of determining the target running speed of the robot 1 according to the material information is implemented when the processor 14 executes the computer program, which is specifically implemented: comparing, the material information with stored material information; and determining, a running speed corresponding to the stored material information matching with the material information is the target running speed.

In this embodiment, the material information of a variety of working surfaces is stored in the robot 1 in advance to form the stored material information, and the running speed corresponding to the stored material information is stored in the robot 1, that is, the optimal moving speed corresponding to different materials is stored in the robot 1 in advance. After robot 1 detects the material information of the working surface, it compares the detected material information with the stored material information, and uses the running speed corresponding to the stored material information that matches with the material information as the target running speed, and then achieve the effect of moving at different speeds according to different materials.

Furthermore, each material corresponds to a running speed.

In any one of the above-mentioned embodiments, furthermore, the step of determining the target running speed of the robot 1 according to the material information is implemented when the processor 14 executes the computer program, which is specifically implemented: confirming, a corresponding material type according to the material information, and the material type includes an easy-to-clean type and a difficult-to-clean type; determining, the material information is of the easy-to-clean type, and control the robot 1 to run at a first speed; and determining, the material information is of the difficult-to-clean type, and control the robot 1 to run at a second speed, and the first speed is greater than the second speed.

In this embodiment, by storing the variety of materials in the robot 1 in advance, and dividing the variety of material information into different material types according to the difficulty of cleaning, the material types include easy-to-clean type and difficult-to-clean type, the easy-to-clean type and the difficult-to-clean type correspond to a running speed. When it is determined that the material information is easy-to-clean type, control the robot 1 to run at the first speed, and when it is determined that the material information is difficult-to-clean type, control the robot 1 to run at the second speed. In one embodiment, the first speed is greater than the second speed, so that when the material information is the easy-to-clean type, the robot 1 moves at a faster speed, and when the material information is the difficult-to-clean type, the robot 1 moves at a slower speed to improve the cleaning efficiency of the robot 1.

Specifically, the first speed and the second speed are the running speeds preset in the robot 1. The easy-to-clean type includes marble and wooden floors, etc., and the difficult-to-clean type includes fiber materials, cotton and linen materials, etc.

In any one of the above-mentioned embodiments, furthermore, before the step of obtaining the material information of the working surface is implemented when the processor 14 executes the computer program, it further implements: starting, the cleaning program; and controlling, the robot to run at a third speed, and the third speed is greater than or equal to the target running speed.

In this embodiment, by turning on the cleaning program of the robot 1, the robot 1 starts cleaning, turns on the detection function of the material of the working surface, and runs at the initial speed, which is the third speed, and then changes the moving speed according to the different materials detected. In one embodiment, the third speed is the moving speed preset in the robot 1, and the third speed is greater than or equal to the target running speed.

In any one of the above-mentioned embodiments, furthermore, when the processor 14 executes the computer program, it further implements: receiving, a stopping cleaning instruction; and stopping, obtaining the material information of the working surface, and close the cleaning program.

In this embodiment, when the robot 1 cleaning is completed or when a stop instruction is received, stop obtaining the material information of the working surface, and close the cleaning program.

Specifically, the robot 1 is a sweeping robot. When the sweeping robot receives a start instruction and starts cleaning, it turns on the material detection function of the working surface and starts running at a constant speed. When it is detected that the ground is a material that is not easy to clean (carpet, etc.), the sweeping robot will automatically be set to low speed mode. When it detected that the ground is of other materials, the sweeping robot will automatically be set to normal mode; when the sweeping robot finishes cleaning or receives a stop command, the ground material detection function is turned off and the cleaning is stopped.

According to some embodiments of the present disclosure, a control method for robot is also provided.

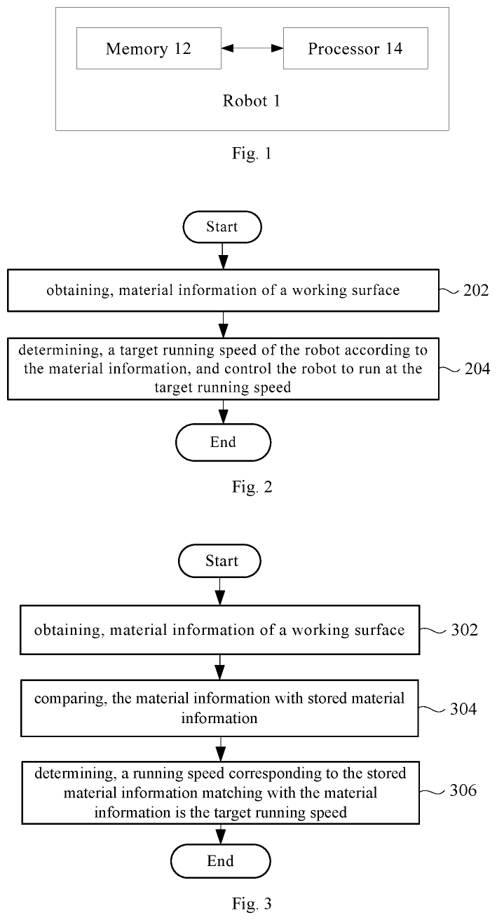

FIG. 2 shows a schematic flow diagram of a control method for robot of the present disclosure. As shown in FIG. 2, the method includes:

Step 202: obtaining, material information of a working surface;

Step 204: determining, a target running speed of the robot according to the material information, and control the robot to run at the target running speed.

The robot provided by the present disclosure can detect the material information of the working surface, and different materials will have different cleaning difficulties. For example, carpets are more difficult to clean than floors. If they move at the same speed when passing through the carpet and passing the floor, the carpet will not be cleaned properly. However, in the embodiment provided by the present disclosure, the robot controls the operating speed according to the material information of the working surface, that is, changes the moving speed of the robot according to the different materials, so that the robot can clean at different speeds for different materials when cleaning. If the detected material of the working surface is a material that is not easy to clean, you can set the speed to a low speed mode accordingly, and then when passing through the working surface that is not easy to clean, at the same cleaning frequency, that is, under the condition that the working frequency of the rolling brush remains unchanged, by slowing down the moving speed of the robot, you can clean the working surface that is not easy to clean at one time, to improve the cleaning effect of the robot. At the same time, compared with the related technology, in order to clean the carpet that is not easy to clean and let the robot clean the carpet multiple times, by slowly moving at a time to clean the carpet, it can reduce the possibility of collision between the robot and other movable objects, to improve the robot cleaning coverage, save user time and improve cleaning efficiency.

FIG. 3 shows another schematic flow diagram of a control method for robot of the present disclosure. As shown in FIG. 3, the method includes:

Step 302: obtaining, material information of a working surface;

Step 304: comparing, the material information with stored material information;

Step 306: determining, a running speed corresponding to the stored material information matching with the material information is the target running speed.

In this embodiment, the material information of a variety of working surfaces is stored in the robot in advance to form the stored material information, and the running speed corresponding to the stored material information is stored in the robot, that is, the optimal moving speed corresponding to different materials is stored in the robot in advance. After robot detects the material information of the working surface, it compares the detected material information with the stored material information, and uses the running speed corresponding to the stored material information that matches with the material information as the target running speed, and then achieve the effect of moving at different speeds according to different materials.

Furthermore, each material corresponds to a running speed.

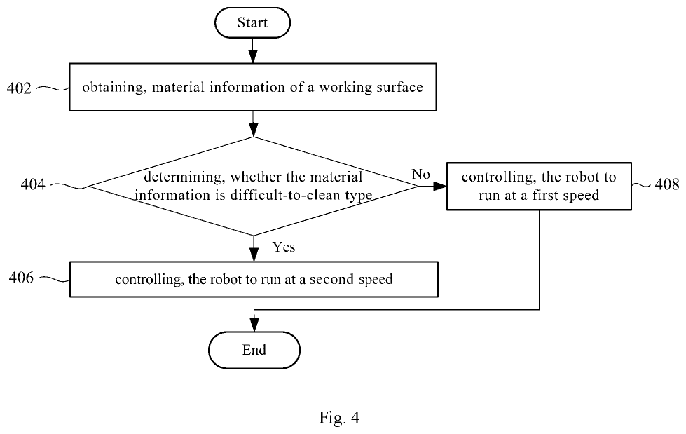

FIG. 4 shows further another schematic flow diagram of a control method for robot of the present disclosure. As shown in FIG. 4, the method includes:

Step 402: obtaining, material information of a working surface;

Step 404: determining, whether the material information is difficult-to-clean type; if it is, skip to step 406, if not, skip to step 408;

Step 406: controlling, the robot 1 to run at a second speed;

Step 408: controlling, the robot 1 to run at a first speed.

In this embodiment, by storing the variety of materials in the robot in advance, and dividing the variety of material information into different material types according to the difficulty of cleaning, the material types include easy-to-clean type and difficult-to-clean type, the easy-to-clean type and the difficult-to-clean type correspond to a running speed. When it is determined that the material information is easy-to-clean type, control the robot to run at the first speed, and when it is determined that the material information is difficult-to-clean type, control the robot to run at the second speed. In one embodiment, the first speed is greater than the second speed, so that when the material information is the easy-to-clean type, the robot moves at a faster speed, and when the material information is the difficult-to-clean type, the robot moves at a slower speed to improve the cleaning efficiency of the robot.

Specifically, the first speed and the second speed are the running speeds preset in the robot. The easy-to-clean type includes marble and wooden floors, etc., and the difficult-to-clean type includes fiber materials, cotton and linen materials, etc.

In any one of the above-mentioned embodiments, furthermore, before step 202, it further includes: starting, the cleaning program; and controlling, the robot to run at a third speed, and the third speed is greater than or equal to the target running speed.

In this embodiment, by turning on the cleaning program of the robot, the robot starts cleaning, turns on the detection function of the material of the working surface, and runs at the initial speed, which is the third speed, and then changes the moving speed according to the different materials detected. In one embodiment, the third speed is the moving speed preset in the robot, and the third speed is greater than or equal to the target running speed.

In any one of the above-mentioned embodiments, furthermore, further comprising: receiving, a stopping cleaning instruction; and stopping, obtaining the material information of the working surface, and close the cleaning program.

In this embodiment, when the robot cleaning is completed or when a stop instruction is received, stop obtaining the material information of the working surface, and close the cleaning program.

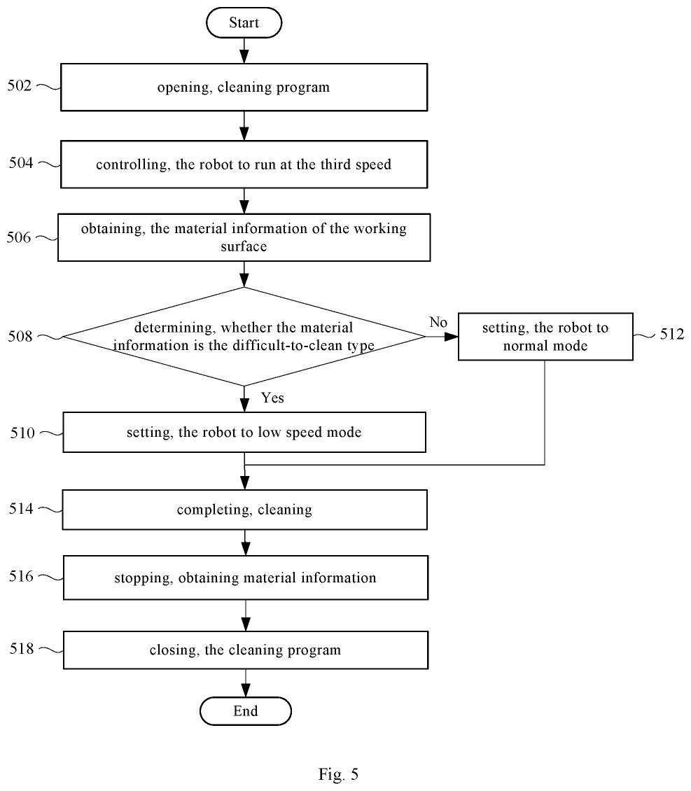

FIG. 5 shows further a schematic flow diagram of a control method for robot of an embodiment of the present disclosure. As shown in FIG. 5, the method includes:

Step 502: opening, cleaning program;

Step 504: controlling, the robot to run at the third speed;

Step 506: obtaining, the material information of the working surface;

Step 508: determining, whether the material information is the difficult-to-clean type; if it is, skip to step 510, if not, skip to step 512;

Step 510: setting, the robot to low speed mode;

Step 512: setting, the robot to normal mode;

Step 514: completing, cleaning;

Step 516: stopping, obtaining material information;

Step 518: closing, the cleaning program.

In this embodiment, specifically, the robot is a sweeping robot. When the sweeping robot receives a start instruction and starts cleaning, it turns on the material detection function of the working surface and starts running at a constant speed. When it is detected that the ground is a material that is not easy to clean (carpet, etc.), the sweeping robot will automatically be set to low speed mode. When it detected that the ground is of other materials, the sweeping robot will automatically be set to normal mode; when the sweeping robot finishes cleaning or receives a stop command, the ground material detection function is turned off and the cleaning is stopped.

According to the embodiments of the present disclosure, a computer-readable storage medium is also provided, on which a computer program is stored, and when the computer program is executed by a processor, the steps of the method described in any one of the above-mentioned embodiments is implemented. Therefore, it has all the effects of the control method for robot, which will not be repeated here.

In the present disclosure, “a plurality of” means two or more, unless otherwise explicitly defined. The terms “installing”, “connected”, “connection”, “fixing” and the like should be understood in a broad sense, for example, “connection” may be a fixed connection, a removable connection or an integral connection; and “connected” may refer to direct connection or indirect connection through an intermediary.

In the description of the present disclosure, the descriptions of the terms “one embodiment”, “some embodiments” and “specific embodiments” and the like mean that specific features, structures, materials or characteristics described in conjunction with the embodiment(s) or example(s) are included in at least one embodiment or example of the present disclosure. In the specification, the schematic representation of the above terms does not necessarily refer to the same embodiment or example. Moreover, the specific features, structures, materials or characteristics described may be combined in a suitable manner in any one or more embodiments or examples.

1. A robot, comprising:
a memory;
a processor, and
wherein a computer program is stored on the memory which when executed by the processor, causes the processor to:
obtain, material information of a working surface; and
determine a target running speed of the robot according to the material information, and control the robot to run at the target running speed.

2. The robot according to claim 1, wherein
the determining of the target running speed of the robot according to the material information, which when further executed by the processor, causes the processor to:
compare, the material information with stored material information; and
determine, a running speed corresponding to the stored material information matching with the material information is the target running speed.

3. The robot according to claim 1, wherein
the determining of the target running speed of the robot according to the material information which when further executed by the processor, causes the processor to:
confirm, a corresponding material type according to the material information, and the corresponding material type comprises an easy-to-clean type and a difficult-to-clean type;
determine, the material information is of the easy-to-clean type, and control the robot to run at a first speed; and
determine, the material information is of the difficult-to-clean type, and control the robot to run at a second speed,
wherein, the first speed is greater than the second speed.

4. The robot according to claim 1, wherein,
before the obtaining of the material information of the working surface is executed by the processor, further causes the processor to:
start, a cleaning program; and
control, the robot to run at a third speed,
wherein, the third speed is greater than or equal to the target running speed.

5. The robot according to claim 4, wherein,
the computer program when executed by the processor:
receive, a stopping cleaning instruction; and
stop, obtaining the material information of the working surface, and close the cleaning program.

6. A control method for robot, comprising:
obtaining, material information of a working surface; and
determining, a target running speed of the robot according to the material information, and control the robot to run at the target running speed.

7. The control method for robot according to claim 6, wherein
the determining of the target running speed of the robot according to the material information comprises:
comparing, the material information with stored material information; and
determining, a running speed corresponding to the stored material information matching with the material information is the target running speed

8. The control method for robot according to claim 6, wherein
the determining of the target running speed of the robot according to the material information further comprises:
confirming, a corresponding material type according to the material information, and the corresponding material type comprises an easy-to-clean type and a difficult-to-clean type;
determining, the material information is of the easy-to-clean type, and control the robot to run at a first speed; and
determining, the material information is of the difficult-to-clean type, and control the robot to run at a second speed,
wherein the first speed is greater than the second speed.

9. The control method for robot according to claim 6, wherein
before the obtaining of the material information of the working surface, the method further comprises:
starting, a cleaning program; and
controlling, the robot to run at a third speed,
wherein the third speed is greater than or equal to the target running speed.

10. The control method for robot according to claim 9, further comprising:
receiving, a stopping cleaning instruction; and
stopping, obtaining the material information of the working surface, and close the cleaning program.

11. A non-transitory computer-readable storage medium on which a computer program is stored, when executed by a processor, causes the processor to:
obtain, material information of a working surface; and
determine, a target running speed of a robot according to the material information, and control the robot to run at the target running speed.
